(19) United States
(12) Patent Application Publication
(10) Pub. No.: US 2001/0037193 A1
(43) Pub. Date: Nov. 1, 2001

(54) Method, apparatus and computer program for generating a feeling in consideration of a self-confident degree

(76) Inventors: Izumi Nagisa, Tokyo (JP); Fumio Saito, Tokyo (JP); Tetsuya Oishi, Tokyo (JP); Nozomu Saito, Tokyo (JP); Hiroshi Shishido, Tokyo (JP)

Correspondence Address: Norman P. Soloway, HAYES, SOLOWAY, HENNESSEY, GROSSMAN & HAGE, P.C., 175 Canal Street, Manchester, NH, 03101, US

(21) Appl. No.: 09/799,837

(22) Filed: Mar. 6, 2001

(30) Foreign Application Priority Data
Mar. 7, 2000 (JP) 61500/2000

(51) Int. Cl. G06F 17/27

(52) U.S. Cl. 704/9; 706/55

(57) ABSTRACT

A feeling generation apparatus for accompanying a reaction and an information proposal of a computer with an agent's feeling. A taste level is assigned to the proposal item. An agent's self-confident degree is calculated for the proposal item. Keywords representing user's response and feeling are extracted from user's input in order to guess user's response and feeling. Agent's feeling is determined according to the agent's self-confident degree, the user's response and feeling. According to the agent's feeling, a reaction sentence and CG animation are generated.

### BACKGROUND OF THE INVENTION

This invention relates to a feeling generator for use in an information retrieval apparatus or an information presentation apparatus to make reaction or information presentation of a computer accompany feelings in a conversation between a user and the computer.

Various techniques to make a computer accompany feelings in a conversation system are already proposed. By way of example, Japanese Unexamined Patent Publication Tokkai No. Hei 6-12,401 or JP-A 6-12401 (Title of Invention; “MOTION SIMULATING DEVICE”) proposes an interactive information input/output system in which an agent has eight fundamental emotions or feelings and a pseudo-feeling is incorporated in the agent so as to change the basis feelings of the agent in accordance with a user's utterance, an accomplishment condition of a task, or the like.

The term “agents” used to strictly mean software executing works for a person and there is an interface agent as one of the agents. The interface agent is an interface where a system actively works upon a user a includes personified interface technique which obviously presents an easy conversation between the system and the user and necessary information at an exquisite timing. A personified agent, which belongs to a category of the interface agent, presents the user with a system state (for example, understanding for a user's question) by adding personified behavior such expression and operation of an animation character to the system. That is, the “personified agent” is one where an expression or a face is added to the interface agent.

More specifically, disclosed in JP-A 6-12401, is the emotion simulating device which comprises a storage means for holding a fundamental element emotion intensity in order to make the agent possess a simulated emotion state. In addition, the emotion simulating device comprises a means for changing the possessed fundamental emotions of the agent on the basis of an event which occurs in an external environment. Furthermore, the emotion simulating device comprises a means for preliminarily determining interactions between the fundamental element emotion emotions within the emotion state and for autonomously changing the emotion state by causing the above-mentioned interactions to occur every a predetermined time interval and by causing increment and decrement to occur between each fundamental element emotion intensity. Furthermore, the emotion simulating device comprises a means for exponentially attenuating each fundamental element emotion intensity with the passage of time and for putting each fundamental element emotion intensity into a steady state or putting the emotion state into a neutral state as a whole after a time sufficiently elapses so that any event does not occur in the external environment.

In addition, Japanese Unexamined Patent Publication Tokkai No. Hei 9-81,632 or JP-A 9-81632 (Title of Invention: “INFORMATION PUBLICATION DEVICE”) proposes a device for estimating a feeling of a user by using feeling words included in a text or sound and frequency of conversations and for determining a response plan of the conversations, that is, a response sentence or response strategy in accordance with kinds of the feeling of the user.

More specifically, disclosed in JP-A 9-81632, is the information publication device which is a device for inputting the data of a plurality of forms including a text, sound, a picture and a pointing position, for extracting the intention and feeling information of the user from the inputted data, for preparing a response plan, and for generating a response of the user. This information publication device comprises a user feeling recognition part for recognizing the feeling state of the user from an internal state of a response plan preparation part, the intention and feeling information of the user and the transition on a time base of interaction condition information including the kind of the prepared response plan. The response plan preparation part selects or changes a response strategy corresponding to the recognized result of the user feeling recognition part and prepares the response plan matched with the response strategy.

Furthermore, Japanese Unexamined Patent Publication Tokkai No. Hei 9-153,145 or JP-A 9-153145 (Title of Invention: “AGENT DISPLAY”) discloses a user interface executing processing suited to a user' purpose and requirement and the skillfulness level. Disclosed in JP-A 9-153134, is the agent display which comprises an agent object storage area for storing attribute data of an agent, a message storage area for storing a message of the agent, and a frame picture storage area for storing a frame picture of the agent. By a clothed image setting means for superscribing a clothes image with a display image of the agent, a field of retrieval object is clearly represented.

In addition, although there is no personified agent, Japanese Unexamined Patent Publication Tokkai No. Hei 10-162,027 or JP-A 10-162027 (Title of Invention: “METHOD AND DEVICE FOR INFORMATION RETRIEVAL”) discloses an information retrieval method and device each of which is capable of easily retrieving, from a huge number of information elements, a particular information element which a user desires. In the information retrieval method and device disclosed in JP-A 10-162027, it is possible to easily retrieve the particular information element desired by the user, from a huge number of programs, by determining the priority order of information according to a basic choice taste peculiar to a user.

Furthermore, Japanese Unexamined Patent Publication Tokkai No. Hei 11-126,017 or JP-A 11-126017 (Title of Invention: “STORAGE MEDIUM, ROBOT, INFORMATION PROCESSING DEVICE AND ELECTRONIC PET SYSTEM”) discloses a technical idea which is capable of realizing a realistic electronic pet by employing various devices. In JP-A 11-126017, an IC card stores internal condition parameters including the feeling of an electronic pet. The internal condition parameters indicate internal conditions of the electronic pet. If electronic pet starts an action based an the internal condition parameters, the IC card stores the updated items in accordance with the motion. The IC card is freely attachable and detachable to the device which functions as the body of the electronic pet. A virtual pet device conducts the processes to display the electronic pet which functions as the body of the electronic pet. The virtual pet device has a slot through which the IC card is freely attachable and detachable.

In addition, Japanese Unexamined Patent Publication Tokkai No. Hei 11-265,239 JP-A 11-265239 (Title of Invention: “FEELING GENERATOR AND FEELING GENERATION METHOD”) proposes a feeling generator which is capable of recalling a prescribed feeling under a new condition satisfying a lead incidental condition by synthesizing recall feeling information and reaction feeling information and generating self feeling information original to a device. In the feeling generator disclosed in the JP-A 11-265239, a reaction feeling generation part generates and outputs the feeling original to the device changed directly reacting with a condition information string for a specified period by a condition description part. A feeling storage generation part generates condition/feeling pair information for which the reaction feeling information by the reaction feeling generation part and a condition string within the specified period by the condition description part are made to correspond to each other and delivers it to a feeling storage description part. A recall information generation part reads the condition string within the specified period from the condition description part, retrieves feeling information corresponding to the condition information string from the feeling storage description part and outputs it as the recall feeling information. A self feeling description part holds the feeling information obtained by synthesizing the reaction feeling information by the reaction feeling generation part and the recall feeling information by the recall feeling generation part as present self feeling information.

There are problems as follows in the above-mentioned Publications.

As a first problem, there is a problem that a conversation can not be realized with feelings such as self-confidence for recommendation or enthusiasm. Such feelings occur in an information retrieval and presentation device for information presented by a computer in accordance with agreement with a retrieval condition or recommendation ranking.

For example, it is impossible for JP-A 6-12401 to accompany propriety of a result or a degree of recommendation with feelings. This is because JP-A 6-12401 determines the feeling of the agent in accordance with an accomplishment conditions of a task or utterance of a user so as to increase, in the task such as a schedule adjustment, a happy feeling of the agent when the task is completed and so as to increase an anger feeling of the agent when the agent does not obtain a speech input from the user although the agent repeats an input request. More specifically, in a case of the task of the schedule adjustment, it is possible for JP-A 6-12401 to accompany a message on completion of the schedule adjustment or a message of the input request with the feelings. However, in a case where there are a plurality of replies or answers as a result of the task of the computer such as a case of retrieving and presenting a proposed schedule for meeting, it impossible for JP-A 6-12401 to accompany the respective answers with the feeling where there is self-confidence for the recommendation along any demand of the user.

There is, as a second problem, a problem such that a response sentence for the feeling has a low flexibility. This is because the response sentence must be determined each developed application although the feeling in the computer side is determined in response to the utterance of the user, the accomplishment condition of the task, or frequency of the conversation and the response sentence for the user is prepared in accordance with the feeling.

For instance, for a response plan so as to order a request, JP-A 9-01632 generates the response sentence of “What do you want with me?” if the feeling is expectation and generates the response sentence of “You may: (1) refer to a schedule of Yamamoto, (2) leave a message for Yamamoto, or (3) connect this line directly to Yamamoto. Please select.” if the feeling is uneasiness.

However, such as a peculiar generation method of the response sentence is disadvantageous in that it is impossible to use the response sentence corresponding to the feeling as it is when other applications are developed and it is therefore necessary to regenerate a new response sentence.

### SUMMARY OF THE INVENTION

It is therefore an object of this invention to provide a feeling generation apparatus which is capable of having a conversation with a feeling such as self-confidence for recommendation or enthusiasm for information such as a retrieved result presented by a computer.

It is another object of this invention to provide a feeling generation apparatus of the type described, which is capable of generating, as a response sentence with the feeling from the computer, a general-purpose response sentence usable in various interactive systems with no response sentence peculiar to one interactive system.

Other objects of this invention will become clear as the description proceeds.

This invention is provided as methods, software products, computers and apparatus for interfacing a computer with a user via an agent.

One of the methods comprises the steps of receiving first sentence that represents a condition for retrieving an item from the user, retrieving an item with reference to the condition, determining an agent's self-confident degree that represents how confidently the agent proposes the item to the user with reference to a level of user's taste predetermined to the item, determining feeling of the agent with reference to the agent's self-confident degree, generating first data for proposing the item to the user with reference to the feeling of the agent, receiving second sentence in response to the first data from the user, extracting predetermined keywords from the second sentence, judging meaning of the second sentence and feeling of the user represented in the second sentence with reference to the extracted keywords, modifying the feeling of the agent with reference to the agent's self-confident, the meaning of the second sentence and the feeling of the user, and generating second data with reference to the modified feeling of the agent.

Another of the methods comprises the steps of receiving a sentence in response to the first data from the user, extracting predetermined keywords from the sentence, judging meaning of the sentence and feeling of the user represented in the sentence with reference to the extracted keywords, determining the feeling of the agent with reference to the judged meaning of the sentence and the judged feeling of the user, and generating data with reference to the determined feeling of the agent.

One of the software products comprises the processes of receiving first sentence that represents a condition for retrieving an item from the user, retrieving an item with reference to the condition, determining an agent's self-confident degree that represents how confidently the agent proposes the item to the user with reference to a level of user's taste predetermined to the item, determining feeling of the agent with references to the agent's self-confident degree, generating first data for proposing the item to the user with reference to the feeling of the agent, receiving second sentence in response to the first data from the user, extracting predetermined keywords from the second sentence, judging meaning of the second sentence and feeling of the user represented in the second sentence with reference to the extracted keywords, modifying the feeling of the agent with reference to the agent's self-confident, the meaning of the second sentence and the feeling of the user, and generating second data with reference to the modified feeling of the agent.

Another of the software products comprises the processes of receiving a sentence in response to the first data from the user, extracting predetermined keywords from the sentence, judging meaning of the sentence and feeling of the user represented in the sentence with reference to the extracted keywords, determining the feeling of the agent with reference to the judged meaning of the sentence and the judged feeling of the user, and generating data with reference to the determined feeling of the agent.

The computer stores one of the above-mentioned software products.

One of the apparatus comprises the devices for receiving first sentence that represents a condition for retrieving an item from the user, retrieving an item with reference to the condition, determining an agent's self-confident degree that represents how confidently the agent proposes the item to the user with reference to a level of user's taste predetermined to the item, determining feeling of the agent with reference to the agent's self-confident degree, generating first data for proposing the item to the user with reference to the feeling of the agent, receiving second sentence in response to the first data from the user, extracting predetermined keywords from the second sentence, judging meaning of the second sentence and feeling of the user represented in the second sentence with reference to the extracted keywords, modifying the feeling of the agent with reference to the agent's self-confident, the meaning of the second sentence and the feeling of the user, and generating second data with reference to the modified feeling of the agent.

Another one of the apparatus comprises the devices for receiving a sentence in response to the first data from the user, extracting predetermined keywords from the sentence, judging meaning of the sentence and feeling of the user represented in the sentence with reference to the extracted keywords, determining the feeling of the agent with reference to the judged meaning of the sentence and the judged feeling of the user, and generating data with reference to the determined feeling of the agent.

### BRIEF DESCRIPTION OF THE DRAWINGS

FIG. 1 is a block diagram of a feeling generation apparatus according to a first embodiment of this invention;

FIGS. 2A and 2B are flowcharts for user in describing operation of the feeling generation apparatus illustrated in FIG. 1;

FIG. 3 shows an example of an agent's self-confident degree model stored in a self-confident degree model memory for use in the feeling generation apparatus illustrated in FIG. 1;

FIG. 4 shows an example of an agent's feeling model stored in an agent's feeling model memory for use in the feeling generation apparatus illustrated in FIG. 1;

FIG. 5 shows another example of an agent's feeling model stored in an agent's feeling model memory for use in the feeling generation apparatus illustrated in FIG. 1;

FIG. 6 shows an example of user's feeling rule table for describing correspondence between keywords and user's feeling;

FIG. 7 shows another example of an agent's feeling model stored in an agent's feeling model memory for use in the feeling generation apparatus illustrated in FIG. 1; and

FIG. 8 is a view showing an example of conversation between an agent and a user in the feeling generation apparatus illustrated in FIG. 1.

### DESCRIPTION OF THE PREFERRED EMBODIMENT

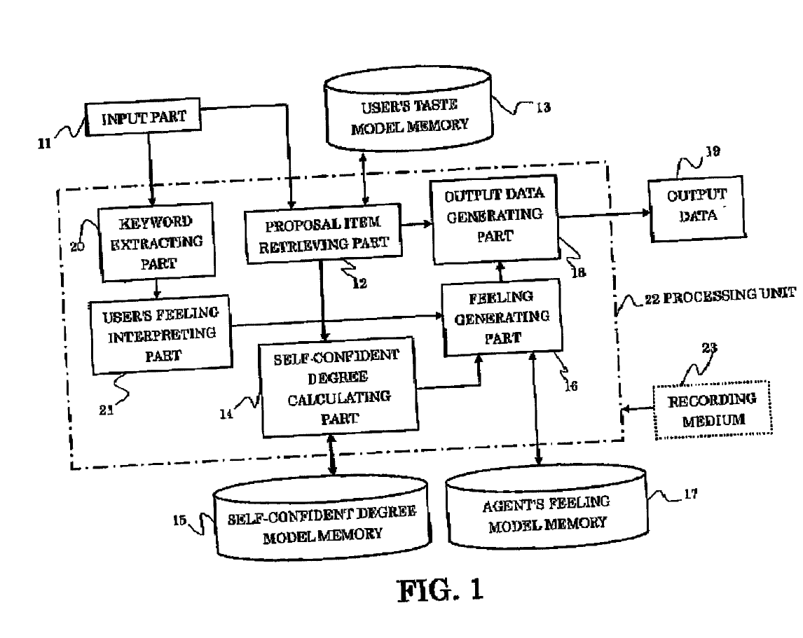

Referring to FIG. 1, the description will proceed to a feeling generation apparatus according to a first embodiment of this invention. The illustrated feeling generation apparatus comprises an input part 11, a proposal item retrieving part 12, a user's taste model memory 13, a self-confident degree calculating part 14, a self-confident degree model memory 15, a feeling generating part 16, an agent's feeling model memory 17, an output data generating part 18, an output part 19, a keyword extracting part 20, and a user's feeling interpreting part 12. In addition, the proposal item retrieving part 12, the self-confident degree calculating part 14, the feeling generating part 16, the output data generating part 18, the keyword extracting part 20 and the user's feeling interpreting part 21 constitute a processing unit 22. Furthermore, the user's taste model memory 13, the self-confident model memory 15, and the agent's feeling model memory 17 constitute a storage unit.

The input part 11 may be, for example, a keyboard, a voice input device, or the like. The proposal item retrieving part 12 retrieves an item such as a restaurant or a music datum to be proposed for a user. The user's taste model memory 13 stores a user's taste model describing user's tastes. The self-confident degree calculating part 14 calculates a particular self-confidence degree for each proposal item in accordance with a user's taste level. The self-confident model memory 15 stores an agent's self-confident model describing correspondences between user's taste levels for the proposal item and agent's self-confident degrees for proposal. The keyword extracting part 20 extracts keywords including feelings from user's responses to proposed items. The user's feeling interpreting part 21 decides a user's feeling with reference to a user's feeling rule table that describes relationship between keywords and user's feelings. The feeling generating part 16 generates a particular agent's feeling according to an agent's self-confident degree of a proposed item output from the agent's self-confident degree calculating part 14, a user's response representing affirmation or negation output from the user's feeling interpreting part 21 and a user's feeling representing that the user is stimulated, disappointed or the like. The agent's feeling model memory 17 stores an agent's feeling model representing correspondences among three attributes of the agent's self-confident degree, the user's response and the user's feeling for the proposal item an agent's feeling. The output data generating part 18 generates, in accordance with the generated agent's feeling, a proposal sentence or speech for proposing the item, a CG (computer graphics) animation, such as an operation and an expression of the agent and so on. The output part 19 may be, for example, a display device or the like.

Referring now to FIGS. 1 through 8, description will be made as regards operation of the feeling generation apparatus illustrated in FIG. 1.

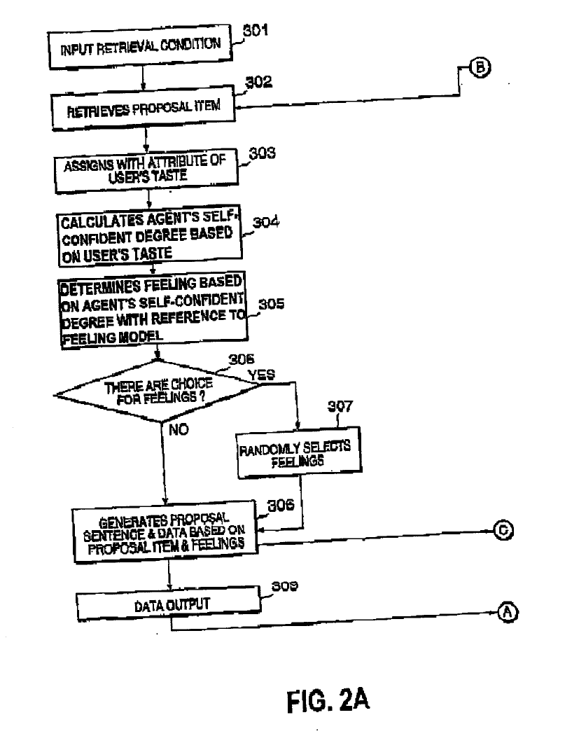

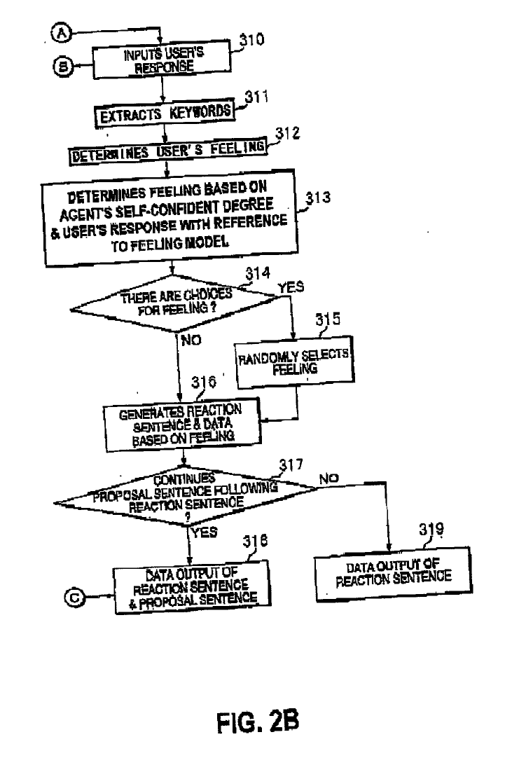

FIG. 2 is a flow chart for showing an example of the operation of the feeling generation apparatus illustrated in FIG. 1.

A user inputs, by using the input part 11, an input condition of an item that desires to propose at a step 301. For example, the user inputs, by using the keyboard or the voice input device, the input condition, such as “I want to eat” at the step 301. The step 301 is followed by a step 302 at which the proposal item retrieving part 12 retrieves, in accordance with an inputted retrieval condition or the condition of a meal in this case, categories of a restaurant or store's names as the item which can be proposed to the user. The step 302 proceeds to a step 303 at which the proposal item retrieving part 12 assigns, with reference to the user's taste model stored in the user's taste model memory 13, the user's taste level to each datum of the retrieved restaurant. For instance, the proposal item retrieving part 12 carries out assignment so that Italian food is a liking, French food is a disliking, and Chinese food is hard to say which. The proposal item and the taste data are sent to the self-confident degree calculating part 14. The step 303 is succeeded by a step 304 at which the self-confident degree calculating part 14 calculates, with reference to the agent's self-confident degree model stored in the self-confident degree model memory 15, a particular agent's self-confident degree for the proposal item.

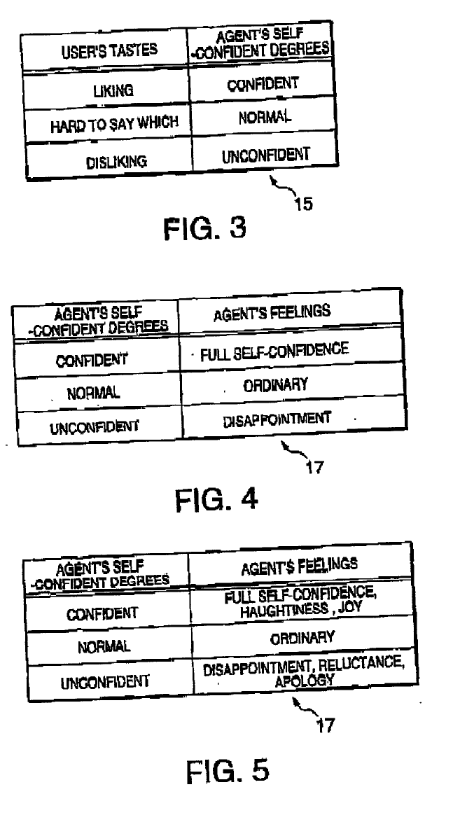

FIG. 3 shows an example of the agent's self-confident degree model stored in the self-confident degree model memory 15. In the example being illustrated in FIG. 3, the user's tastes are made to correspond to the agent's self-confident degrees as follows. That is, if the user's taste is the “liking”, the agent's self-confident degree for the proposal is “confident.” If the user's taste if “hard to say which”, the agent's self-confident degree is “normal.” If the user's taste is the “disliking”, the agent's self-confident degree for the proposal is “unconfident.”

In the example being illustrated, inasmuch as the item of Italian food is the “liking”, Italian food is attached to an attribute of “confident”. Likewise, the self-confident degree calculating part 14 attaches attributes of “unconfident” and “normal” to French food and Chinese food, respectively. The self-confident degree calculating part 14 delivers those attributes to the feeling generating part 16. The step 304 is followed by a step 305 at which the feeling generating part 16 determines, with reference to the agent's feeling model stored in the agent's feeling model memory 17, a particular agent's feeling on proposing of the item.

FIG. 4 shows an example of the agent's feeling model stored in the agent's feeling model memory 17. In the example being illustrated in FIG. 4, the agent's self-confident degrees are made to correspond to the agent's feelings as follows. That is, if the agent's self-confident degree is “confident”, its agent's feeling is made to correspond to “full self-confidence.” If the agent's self-confident degree is “normal”, its agent's feeling is made to correspond to “ordinarily.” If the agent's self-confident degree is “unconfident”, its agent's feeling is made to correspond to “disappointment.”

The step 305 proceeds to a step 306 at which the feeling generating part 16 determines whether or not there are a plurality of choices for the particular agent's feeling that enables to determine by the agent's feeling model stored in the agent's feeling model memory 17.

If there are no plurality of choices such as the agent's feeling model illustrated in FIG. 4, the feeling generating part 16 determines the particular agent's feeling shown in FIG. 4 and sends it with the proposal item to the output data generating part 18.

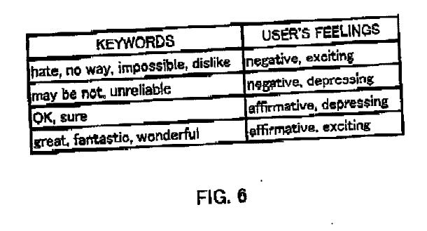

FIG. 5 shows another example of the agent's feeling model having a plurality of choices. In the example being illustrated in FIG. 5, the agent's self-confident degrees are corresponded to the agent's feeling as follows. That is, if the agent's self-confident degree is “confident”, its agent's feeling is made to correspond to “full self-confidence”, “haughtiness”, “joy”, or the like. If the agent's self-confident degree is “normal”, its agent's feeling is made to correspond to “ordinarily.” If the agent's self-confident degree is “unconfident”, its agent's feeling is made to correspond to “disappointment”, “reluctance”, “apology”, or the like.

If there are a plurality of choices for the particular agent's feeling, the feeling generating part 16 selects and determines one of the choices. A selection method for the particular agent's feeling may be a method of randomly selecting one of the choices (step 307). Alternatively, the selection method may be for sequentially selecting one of the choices or the like.

On the basis of the particular agent's feeling and the proposal item sent from the feeling generating part 16, the output data generating part 18 generates, in accordance with the particular agent's feeling, the speech for proposing the item, the CG animation such as operation and the expression of the agent and so on (step 308).

For instance, attention will be directed to a case where the item of Italian food is proposed based on the agent's feeling of “full self-confidence.” Under the circumstances, the output data generating part 18 generates a proposal speech such as “I recommend Italian food!” and carries out instruction operation where the CG character instructs this proposal speech with a smiling expression and with jumping up and down, and thereby represents the feeling of the proposal of full self-confidence. In addition, attention will be directed to another case where the item of Chinese food is proposed with the agent's feeling of “ordinarily.” Under the circumstances, the output data generating part 18 generates a proposal speech such as “May I offer you Chinese food?” and carries out instruction operation whose the CG character instructs this proposal speech with a normal expression, and thereby represents the feeling of the proposal of ordinarily. Attention will be directed to still another case where the item of French food or dish is proposed with the agent's feeling of “disappointment.” Under the circumstances, the output data generating part 18 generates a proposal speech such as “Nothing else but French food.” and carries out instruction operation where the CG character instructs this proposal speech with a sadly expression with drooping CG character's shoulders, and thereby represents the feeling of the proposal with not quite recommendation and with disappointment. The generated CG character and voice are displayed by the output part 19 (step 309).

Next, description will be made about operation of the feeling generation apparatus in response to user's response toward the proposal item. It is assumed that the feeling generation apparatus answers “I recommend Italian food!”, and then, the user inputs some words that mean affirmation/negation to the proposal item, together with strength of feeling (step 310. The inputted words are sent to the proposal item retrieving part 12 in order that the part 12 retrieves another proposal item according to another inputted retrieval condition (step 302). Simultaneously, the inputted words are sent to the keyword extracting part 20 in order that the part 20 extracts, from the inputted words, keywords that includes the user's response and feeling.

Keywords are extracted as follows. The keyword extracting part 20 extracts previously registered keywords that means various feeling, from the words inputted from the input part 11 by the user (step 311). The registered keywords are included in a dictionary for speech recognition if the input part 11 is a speech recognition device. Extracted keywords are sent to the user's feeling interpreting part 21. The user's feeling interpreting part 21 determines current user's feeling with reference to a user's feeling rule table describing correspondence between user's feelings and keywords (step 312).

For example, as the user's feeling rule table shown in FIG. 6, if the inputted words include keywords that mean negative reply and agitated feeling such as “hate”, “no way”, “impossible”, and “dislike”, then the user's feeling interpreting part 21 assigns the user's response to “negative” and the user's feeling to “exciting”. If the inputted keywords mean negative reply and cheerless feeling such as “maybe not” and “unreliable”, then the part 21 assigns the user's response to “negative” and the user's feeling to “depressing”. If the inputted keywords mean affirmative reply and excited feeling such as “great”, “fantastic” and “wonderful”, then the part 21 assigns the user's response to “affirmative” and the user's feeling to “exciting”. And if the inputted keywords mean affirmative reply and cheerless feeling such as “OK” and “sure”, the part 21 assigns the user's response to “affirmative” and the user's feeling to “depressing”. As mentioned above, the user's feeling interpreting part 21 determines whether the user's response is affirmative/negative and the user's feeling is exciting/depressing according to the inputted words. The determined user's response and feeling are sent to the feeling generating part 16.

The feeling generating part 16 determines current agent's feeling with reference to the agent's feeling model that is stored in the agent's feeling model memory 17. The agent's feeling model describes correspondences among agent's self-confident degrees to the proposal items, user's replies of affirmative/negative, user's feeling of exciting/depressing and agent's feeling (step 313).

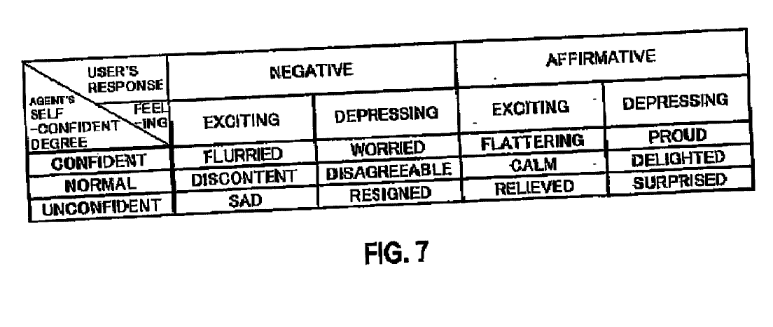

According to the agent's feeling model shown in FIG. 7, if the feeling generation apparatus proposes an item with a agent's self-confident degree “confident” and determines the user'response and feeling to the proposal as “negative” and “exciting” respectively, then the apparatus assigns current agent's feeling to “flurried”. If the item is proposed together with the degree “confident” and the user's response and feeling are “negative” and “depressing” respectively, then the apparatus assigns current agent's feeling to “worried”. If the item is proposed along with the degree “confident” and the user's response and feeling are “affirmative” and “depressing” respectively, then the apparatus assigns current agent's feeling to “flattered”. And if the item is proposed along with the degree “confident” and the user's response and feeling are “affirmative” and “exciting” respectively, than the apparatus assigns current agent's feeling to “proud”.

Similarly, if the item is proposed together with the degree “normal” and the user's response and feeling are “negative” and “exciting” respectively, then the apparatus assigns current agent's feeling to “discontentment”. If the item is proposed with the degree “normal” and the user's response and feeling are “negative” and “depressing” respectively, then the apparatus assigns current agent's feeling to “disagreeable”. If the item is proposed with the degree “normal” and the user's response and feeling are “affirmative” and “depressing” respectively, then the apparatus assigns current agent's feeling to “calm”. And if the item is proposed with the degree “normal” and the user's response and feeling are “affirmative” and “exciting” respectively, then the apparatus assigns current agent's feeling to “delighted”.

And similarly, if the item is proposed with the degree “unconfident” and the user's response and feeling are “negative” and “exciting” respectively, then the apparatus assigns current agent's feeling to “sad”. If the item is proposed with the degree “unconfident” and the user's response and feeling are “negative” and “depressing” respectively, then the apparatus assigns current agent's feeling to “resigned”. If the item is proposed with the degree “unconfident” and the user's response and feeling are “affirmative” and “depressing” respectively, then the apparatus assigns current agent's feeling to “relieved”. And if the item is proposed with the degree “unconfident” and the user's response and feeling are “affirmative” and “exciting” respectively, then the apparatus assigns current agent's feeling to “surprised”.

The step 313 is followed by a step 314 at which the feeling generating part 16 determines whether or not there are a plurality of choices for particular agent's feeling which enables to determine by the agent's feeling model stored in the agent's feeling model memory 17. When there is no choice as shown in FIG. 7, the feeling generating part 16 determines the particular agent's feeling in accordance with a table illustrated in FIG. 7 and sends the particular agent's feeling to the output data generating part 18. Responsive to the particular agent's feeling sent from the feeling generating part 16, the output data generating part 18 generates a speech, an operation, and an expression for reacting to the user's response.

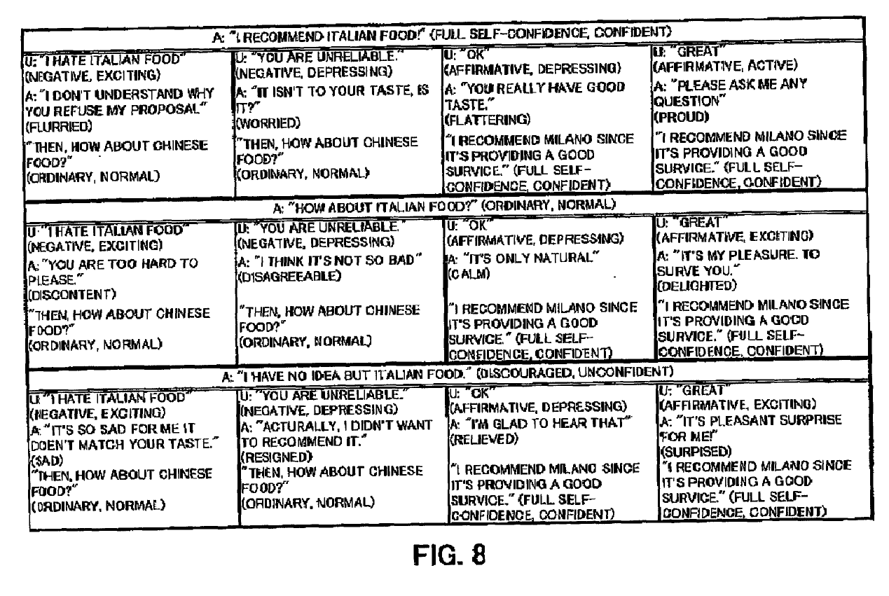

FIG. 8 shows an example of conversation between the agent and the user. It will be assumed that the user denies such as “I hate it” for the proposal item of “I recommend Italian food. Would you like it!” with the feeling of “full self-confidence”, namely, with the agent's self-confident degree “confident”. In this event, the keyword extracting part 20 extracts the keyword “hate” and the user's feeling interpreting part 21 assigns the user's response and feeling to “negative” and “exciting”, respectively, with reference to the keyword “hate”. Next, the feeling generating part 16 generates an agent's feeling corresponding to the agent's self-confident degree “confident”, the user's response “negative” and the user's feeling “exciting” with reference to the agent's feeling model stored in the agent's feeling model memory 17. In this case, the feeling generating part 16 outputs “flurried” as the agent's feeling. According to the agent's feeling “flurried”, the output data generating part 18 generates a reaction sentence corresponding to “flurried” such as “I don't understand why you refuse my proposal!” and CG animation data representing that the agent in a cold sweat is tearing its hair out.

To the same proposal item above, it will be assumed that the user inputs words such as “You are unreliable”. In this case, the keyword extracting part 20 extracts the keyword “unreliable” and the user's feeling interpreting part 21 assigns the user's response and feeling to “negative” and “depressing”, respectively. Next, the feeling generating part 16 determines current agent's feeling corresponding to the agent's self-confident degree “confident”, the user's response “negative” and the user's feeling “depressing” as “worried”. Then, the output data generating part 18 generates a reaction sentence corresponding to “worried” such as “It isn't to your taste, is it?” and CG animation data representing that the agent frowns and tilts its head.

The two cases have been mentioned above. In both the first and second cases, the user's responses are the same. On the other hand, the user's feelings in the first and second cases are different from each other. It is noted that, according to the difference between the user's feelings in the first and second cases, the agent reacts to the user in different way.

In the following examples, it is assumed that the feeling generation apparatus proposes a proposal with the feeling “disappoint”, namely, with an agent's self-confident degree “unconfident”. The proposal is outputted to the user sentences such as “I have no idea but Italian food.”

In response to the proposal, it is assumed that the user inputs “No way”. In this case, the keyword extracting part 21 assigns the user's response and feeling to “negative” and “exciting” respectively. With reference to the agent feeling model stored in the agent feeling model memory 17, the feeling generating part 16 determines current agent feeling corresponding to the agent's self-confident degree “unconfident”, the user's response “negative” and the user's feeling “exciting” as “sad”. In response to the agent feeling “sad”, the output data generating part 18 generates a reaction sentence such as “It's so sad for me it doesn't match your taste.” And further, the output data generating part 18 generates CG animation data representing that the agent is covering its face with hand and sobbing out the reaction sentence.

On the other hand, in response to the proposal with a agent's self-confident degree “unconfident”, it is assumed that the user inputs “Maybe not”. In this case, the keyword extracting part 20 extracts keywords “maybe not” and then, the user's feeling interpreting part 21 assigns the user's response and feeling to “negative” and “depressing”, respectively. With reference to the agent feeling model stored in the agent feeling model memory 17, the feeling generating part 16 determines current agent feeling corresponding to the agent's self-confident degree “unconfident”, the user's response “negative” and the user's feeling “depressing” as “resigned”. In response to the agent feeling “resigned”, the output data generating part 18 generates a reaction sentence such as “Ah, that's exactly what I thought.” And further, the output data generating part 18 generates CG animation data representing that the agent is suddenly lying flat on its face with a sigh.

In the first two cases mentioned above, the feeling generation apparatus proposed an item with the agent's self-confident degree “confident”. On the other hand, in the last two cases mentioned above, the apparatus proposed an item with the degree “unconfident”. It is noted that even if the user's response and feeling are determined as the same, the agent's reaction to the item with the agent's self-confident degree “confident” is different from that with “unconfident” because the agent's reaction is generated according to the agent's self-confident degree.

Even if the user's response to a proposal item is “affirmative”, the feeling generation apparatus determines the agent's feeling and generates a reaction sentence and CG animation in the same ways mentioned above. For example, it is assumed that the user inputs “That's great!” and the user's response and feeling are assigned to “affirmative” and “exciting” respectively. In this case, the feeling generating part 16 generates the agent's feeling “proud” with reference to the agent's feeling model stored in the agent's feeling model memory 17. Then, the output data generating part 18 generates a reaction sentence correspond to the agent's feeling “proud” such as “Please leave everything to me” and CG animation data representing the agent is winking with its head held high.

Similarly, the feeling generation apparatus determines the agent's feeling and generates a reaction sentence and CG animation if the agent's self-confident degree is “normal” or “unconfident”.

The step 316 proceeds to a step 317 at which the output data generating part 18 determines whether or not a proposal sentence is generated following the reaction sentence. When a next item is retrieved by the proposal item retrieving part 12, the step 317 is succeeded by a step 318 at which the output data generating part 18 generates the proposal item following the reaction sentence such as “I don't understand why you refuse my proposal!” When the next item is not retrieved by the proposal item retrieving part 12, the step 317 is followed by a step 319 at which the output part 19 outputs only the reaction sentence.

Now, the description will be made as regards generation of the proposal sentence following the reaction sentence. When the user makes the affirmative response or the negative response for the proposed item such as “Italian food” at the step 310, the proposal item retrieving part 2 carries out, in response to the user's response, the retrieval in conformity with the condition at the step 302. For instance, it will be assumed that the user makes the negative response such as “No” for the proposal of “Italian food.” In this event, the proposal item retrieving part 12 retrieves a category of different restaurant except for Italian food. The proposal item retrieving part 12 refers to the user's taste model stored in the user's taste model memory 13, determines a proposal item of the category such as “Chinese food=hard to say which” matched with a next user's taste following Italian food, and sends the determined proposal item to the self-confident degree calculating part 14. The self-confident degree calculating part 14 calculates the particular agent's self-confident degree on the basis of the degree of the user's taste. The feeling generating part 16A determines the particular agent's feeling on the basis of the particular agent's self-confident degree. The output data generating part 18 generates the proposal speech of “May I offer you Chinese food?” for proposing the item of Chinese food with the feeling of “ordinarily” or the like and generates operation and expression of the CG character therefor.

In the step 314 in the flowchart of FIG. 2, current agent feeling is determined with reference to the agent's feeling model stored in the agent's feeling model memory 17. Corresponding to a single agent's self-confident degree, user's response and feeling, the agent's feeling model may store plural agent's feelings. In this case, current agent feeling may be randomly selected from the plural feelings. Further, current agent's feeling may be sequentially selected from the plural feelings.

Thus, in this invention, an agent's feeling is generated with reference to an attribute of agent's self-confident degree that is given to a proposal item according to the user's taste. Consequently, this invention can add feeling such as confidence, enthusiasm or the like to a proposal.

Further, in this invention, an agent's feeling corresponding to a reaction sentence is determined according to an agent'self-confident degree, a user's response and a user's feeling. The agent's self-confident degree corresponds to a proposal item and is an attribute where uses are not limited to a specific purpose. Thus, the agent's feeling is available for various kinds of data such as music data, shop names, hotel names, schedule data of various kinds of software products. Consequently, this invention allows plural software products to a single system for generating reaction sentences with feeling.

And further, in this invention, current agent's feeling and a reaction sentence corresponding to the current agent's feeling changes in response to user's feeling that is determined from user's input. User's response representing affirmative/negative and user's feeling represented exciting/depressing are determined according to extracted keywords from user's input. Consequently, in this invention, the agent can appropriately react to user's input.

While this invention has thus far been described in conjunction with a preferred embodiment thereof, it will now be readily possible for those skilled in the art to put this invention into various other manners. For example, computer programs realizing each part in the processing unit 22 in the above-mentioned embodiments may be recorded or stored in the recording medium 23 depicted at broken lines in FIG. 1. In addition, data stored in each memory 13, 15 or 17 in the above-mentioned embodiment may be recorded or store din a recording medium. The “recording medium” means a computer readable recording medium for recording computer programs or data and, in particularly, includes a CD-ROM, a magnetic disk such as a flexible disk, a semiconductor memory, or the like. The recording medium 23 may be a magnetic tape for recording programs or data and may be distributed through a communication line.

What is claimed is:

1. A method of interfacing a computer with a user via an agent, comprising the steps of:
receiving first sentence that represents a condition for retrieving an item from the user;
retrieving an item with reference to the condition;
determining an agent's self-confident degree that represents how confidently the agent proposes the item to the user with reference to a level of user's taste predetermined to the item;
determining a feeling of the agent with reference to the agent's self-confident degree;
generating first data for proposing the item to the user with reference to the feeling of the agent;
receiving second sentence in response to the first data from the user;
extracting predetermined keywords from the second sentence;
judging meaning of the second sentence and feeling of the user represented in the second sentence with reference to the extracted keywords;
modifying the feeling of the agent with references to the agent's self-confident, the meaning of the second sentence and the feeling of the user; and
generating second data for replying to the second sentence with reference to the modified feeling of the agent.

2. A method of interfacing a computer with a user via an agent, comprising the steps of:
receiving a sentence in response to the first data from the user;
extracting predetermined keywords from the sentence;
judging meaning of the sentence and feeling of the user represented in the sentence with reference to the extracted keywords;
determining the feeling of the agent with reference to the judged meaning of the sentence and the judged feeling of the user; and
generating data for replying to the sentence with reference to the determined feeling of the agent.

3. A software product for interfacing a computer with a user via an agent, making the computer execute the processes of:
receiving first sentence that represents a condition for retrieving an item from the user;
retrieving an item with reference to the condition;
determining an agent's self-confident degree that represents how confidently the agent proposes the item to the user with reference to a level of user's taste predetermined to the item;
determining feeling of the agent with reference to the agent's self-confident degree;
generating first data for proposing the item to the user with reference to the feeling of the agent;
receiving second sentence in response to the first data from the user;
extracting predetermined keywords from the second sentence;
judging meaning of the second sentence and feeling of the user represented in the second sentence with reference to the extracted keywords;
modifying the feeling of the agent with reference to the agent's self-confident, the meaning of the second sentence and the feeling of the user; and
generating second data for replying to the second sentence with reference to the modified feeling of the agent.

4. A software product for interfacing a computer with a user via an agent, making the computer execute the processes of:
receiving a sentence in response to the first data from the user;
extracting predetermined keywords from the sentence;
judging meaning of the sentence and feeling of the user represented in the sentence with reference to the extracted keywords;
determining the feeling of the agent with reference to the judged meaning of the sentence and the judged feeling of the user; and
generating data for replying to the sentence with reference to the determined feeling of the agent.

5. A computer storing a software product in its storage device, the software product making the computer execute the processes of:
receiving first sentence that represents a condition for retrieving an item from the user;
retrieving an item with reference to the condition;
determining an agent's self-confident degree that represents how confidently the agent proposes the item to the user with reference to a level of user's taste predetermined to the item;
determining feeling of the agent with reference to the agent's self-confident degree;
generating first data for proposing the item to the user with reference to the feeling of the agent;
receiving second sentence in response to the first data from the user;
extracting predetermined keywords from the second sentence;
judging meaning of the second sentence and feeling of the user represented in the second sentence with reference to the extracted keywords;
modifying the feeling of the agent with reference to the agent's self-confident, the meaning of the second sentence and the feeling of the user; and
generating second data for replying to the second sentence with reference to the modified feeling of the agent.

6. A computer storing a software product in its storage device, the software product making the computer execute the processes of:
receiving a sentence in response to the first data from the user;
extracting predetermined keywords from the sentence;
judging meaning of the sentence and feeling of the user represented in the sentence with reference to the extracted keywords;
determining the feeling of the agent with reference to the judged meaning of the sentence and the judged feeling of the user; and
generating data for replying to the sentence with reference to the determined feeling of the agent.

7. An apparatus which interfaces with a user via an agent, comprising the devices for:
receiving first sentence that represents a condition for retrieving an item from the user;
retrieving an item with reference to the condition;
determining an agent's self-confident degree that represents how confidently the agent proposes the item to the user with references to a level of user's taste predetermined to the item;
determining feeling of the agent with reference to the agent's self-confident degree;
generating first data for proposing the item to the user with reference to the feeling of the agent;
receiving second sentence in response to the first data from the user;
extracting predetermined keywords from the second sentence;
judging meaning of the second sentence and feeling of the user represented in the second sentence with reference to the extracted keywords;
modifying the feeling of the agent with reference to the agent's self-confident, the meaning of the second sentence and the feeling of the user; and
generating second data for replying to the second sentence with reference to the modified feeling of the agent.

8. An apparatus which interfaces with a user via an agent, comprising the devices for:
receiving a sentence in response to the first data from the user;
extracting predetermined keywords from the sentence;
judging meaning of the sentence and feeling of the user represented in the sentence with reference to the extracted keywords;
determining the feeling of the agent with reference to the judged meaning of the sentence and the judged feeling of the user; and
generating data for replying to the sentence with reference to the determined feeling of the agent.
